(19) United States
(12) Patent Application Publication
(10) Pub. No.: US 2005/0102523 A1
(43) Pub. Date: May 12, 2005

(54) Smartcard with cryptographic functionality and method and system for using such cards

(75) Inventors: Keith Alexander Harrison, Woodcroft Chepstow (GB); Liqun Chen, Bristol (GB); Marco Casassa Mont, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/982,500

(22) Filed: Nov. 5, 2004

(30) Foreign Application Priority Data
Nov. 8, 2003 (GB) 0326100.5

(51) Int. Cl. H04K 1/00

(52) U.S. Cl. 713/185

(57) ABSTRACT

A smartcard is provided that stores a secret associated with the user of the card. The smartcard is arranged to map an input string to a first element of an algebraic group according to a known mapping function, to multiply the first element by the stored secret to form a second element of the same algebraic group such that there exists a computable bilinear map for the first and second elements, and to output this second element. This selection of the limited functionality of the smartcard enables it to be employed in the provision of a range of cryptographic services such as encryption, decryption and signature generation. The smartcard is therefore suitable for use in an organisation where multiple cryptographic services are required.

### FIELD OF THE INVENTION

The present invention relates to smartcards with cryptographic functionality and to methods and systems using such smartcards to provide cryptographic services in an organisation.

As used herein, the term “organisation” is intended to cover any formal or informal body such as a commercial enterprise, interest group, international organisation or country. Furthermore, the term “smartcard” as used herein is intended to include any small-sized object (such as a credit-card sized object) incorporating processing functionality, usually on a single chip, that is externally accessible by any suitable interface whether using physical contacts or non-contact means such as inductive, capacitive, photoelectric or the like. The processing functionality can be based on a program-controlled processor or dedicated circuitry. A smartcard can be powered in any suitable manner such as by an external source via physical contacts, by an on-card power source, by inductive coupling, or by a photo-voltaic arrangement. As is well known, a smartcard will normally include both volatile and non-volatile memory. Where the memory is used to store secrets, at least the memory should be tamper resistant/tamper proof.

### BACKGROUND OF THE INVENTION

In many organisations, a variety of cryptographic functions are used to secure processes operated by the organisation, these functions including, for example, authentication, digital signatures, key generation, etc. These cryptographic functions generally involve use of a secret associated with a user who may either be representing themselves or a particular entity within the organisation.

Where only a single cryptographic function is required, it is convenient to provide the user's secret, and associated cryptographic functionality for using the secret, on a smartcard that the user can carry around. Provision of the cryptographic functionality on the smartcard is necessary in order to ensure that the secret is never required to be exported off the card.

Presently, most available smartcards are single function cards, such as a smartcard used for secure storage, a smartcard used for entity authentication, a smart card used for digital signature, a smartcard used for decryption or so on.

Where a user is required to be involved in the use of multiple different cryptographic functions, as may well be the case in a large organisation, it becomes inconvenient and expensive to provide a respective smartcard for each cryptographic function to be implemented.

Accordingly, it has been proposed to provide a smartcard with multiple fixed functions, each function operating independently of the other functions. One example is described in U.S. A-2,002,0100808, titled “Smart card having multiple controlled access electronic pockets” and filed on Nov. 30, 2001. This document describes a multifunction smartcard having a purse with a plurality of pockets capable of registering a stored value limited to a predetermined purpose.

Using this approach to provide a smartcard for use in providing multiple cryptographic functions is too expensive and complex as it requires the smartcard to generate and hold a number of different keys each for one specific purpose.

It is an object of the present invention to provide a smartcard that can be used in providing multiple cryptographic services yet is less expensive and complex than previously-proposed solutions.

As will become apparent hereinafter, embodiments of the present invention make use of cryptographic techniques using bilinear mappings. Accordingly, a brief description will now be given of certain such prior art techniques.

In the present specification, G₁ and G₂ denote two algebraic groups of large prime order l in which the discrete logarithm problem is believed to be hard and for which there exists a non-degenerate computable bilinear map p, for example, a Tate pairing or Weil pairing. Note that G₁ is a [l]-torsion subgroup of a larger algebraic group G₀ and satisfies [l]P=O for all PεG₁ where 0 is the identity element, l is a large prime, and l*cofactor=number of elements in G₀. The group G₂ is a subgroup of a multiplicative group of a finite field.

For the Weil pairing: the bilinear map p is expressed as
p: G₁×G₁→G₂.
The Tate pairing can be similarly expressed though it is possible for it to be of asymmetric form:
p: G₁×G₀→G₂
Generally, the elements of the groups G₀ and G₁ are points on an elliptic curve (typically, though not necessarily, a supersingular elliptic curve); however, this is not necessarily the case.

As is well known to persons skilled in the art, for cryptographic purposes, modified forms of the Weil and Tate pairings are used that ensure p(P,P)≈1 where PεG₁; however, for convenience, the pairings are referred to below simply by their usual names without labeling them as modified. Further background regarding Weil and Tate pairings and their cryptographic uses can be found in the following references:
G. Frey, M. Müller, and H. Ruck. The Tate pairing and the discrete logarithm applied to elliptic curve cryptosystems. IEEE Transactions on Information Theory, 45(5): 1717-1719, 1999.
D. Boneh and M. Franklin. Identity based encryption from the Weil pairing. In Advances in Cryptology—CRYPTO 2001, LNCS 2139, pp. 213-229, Springer-Verlag, 2001.

For convenience, the examples given below assume the use of a symmetric bilinear map (p: G₁×G₁→G₂) with the elements of G₁ being points on an elliptic curve; however, these particularities, are not to be taken as limitations on the scope of the present invention.

As the mapping between G₁ and G₂ is bilinear, exponents/multipliers can be moved around. For example if a, b, cεZ (where Z is the set of all integers) and P, QεG₁ then

$$\begin{matrix}{p ( aP , bQ )}^{c} = {p ( aP , cQ )}^{b} = {p ( bP , cQ )}^{a} = {p ( bP , aQ )}^{c} \\ = {p ( cP , aQ )}^{b} = {p ( cP , bQ )}^{a} = {p ( abP , Q )}^{c} \\ = p ( abP , cQ ) = {p ( P , abQ )}^{c} = p ( cP , abQ ) \\ = ⋯ \\ = p ( abcP , Q ) = p ( P , abcQ ) = {p ( P , Q )}^{abc}\end{matrix}$$

Additionally, the following cryptographic hash functions are defined:
H₁: {0,1)*→G₁
H₂ {0,1)*→Z^{*}ₗ
H₃: G₂→{0,1)*
The function H₁( ) is often referred to as the mapToPoint function as it serves to convert a string input to a point on the elliptic curve being used.

A normal public/private key pair can be defined for a trusted authority:
the private key is s
   where sεZₗ and
the public key is (P, R)
   where P and R are respectively master and derived public elements with PεG₁ and RεG₁, P and R being related by R=sP

Additionally, an identifier based public key/private key pair can be defined for a party with the cooperation of the trusted authority. As is well known to persons skilled in the art, in “identifier-based” cryptographic methods a public, cryptographically unconstrained, string is used in conjunction with public data of a trusted authority to carry out tasks such as data encryption or signing. The complementary tasks, such as decryption and signature verification, require the involvement of the trusted authority to carry out computation based on the public string and its own private data In message-signing applications and frequently also in message encryption applications, the string serves to “identify” a party (the sender in signing applications, the intended recipient in encryption applications); this has given rise to the use of the label “identifier-based” or “identity-based” generally for these cryptographic methods. However, at least in certain encryption applications, the string may serve a different purpose to that of identifying the intended recipient and, indeed, may be an arbitrary string having no other purpose than to form the basis of the cryptographic processes. Accordingly, the use of the term “identifier-based” herein in relation to cryptographic methods and systems is to be understood simply as implying that the methods and systems are based on the use of a cryptographically unconstrained string whether or not the string serves to identify the intended recipient. Furthermore, as used herein the term “string” is simply intended to imply an ordered series of bits whether derived from a character string, a serialized image bit map, a digitized sound signal, or any other data source.

In the present case, the identifier-based public/private key pair defined for the party has a public key Q_{ID} and private key S_{ID} where Q_{ID}, S_{ID}εG₁. The trusted authority's normal public/private key pair (P,R/s) is linked with the identifier-based public/private key by

S_{ID}=sQ_{ID} and Q_{ID}=H₁ (ID)
where ID is the identifier string for the party.

Some typical uses for the above described key pairs will now be given with reference to FIG. 1 of the accompanying drawings that depicts a trusted authority 1 with a public key (P, sP) and a private key s. A party A serves as a general third party whilst for the identifier-based cryptographic tasks (IBC) described, a party B has an IBC public key Q_{ID} and an IBC private key S_{ID}, this latter key being generated by private-key generation functionality of the trusted authority 1 from the identifier ID of party B. The trusted authority will generally only provide the party B with its private key after having checked that party B is entitled to the identifier ID (for example, by having verified that party B meets certain conditions specified in the identifier, such as an identity condition).

Short Signatures (see dashed box 2): The holder of the private key s (that is, the trusted authority 1 or anyone to whom the latter has disclosed s) can use s to sign a bit string; more particularly, where m denotes a message to be signed, the holder of s computes:
V=sH₁(m).

Verification by party A involves this party checking that the following equation is satisfied:
p(P,V)=p(R, H₁(m))

This is based upon the mapping between G₁ and G₂ being bilinear exponents/multipliers, as described above. That is to say,

$$\begin{matrix}p ( P , V ) = p ( P , {sH}_{1} ( m ) ) \\ = {p ( P , {H}_{1} ( m ) )}^{s} \\ = p ( sP , {H}_{1} ( m ) ) \\ = p ( R , {H}_{1} ( m ) )\end{matrix}$$

Further description of short signatures of this form can be found in “Short signatures from the Weil pairing”, Boneh, D., B. Lynn, and H. Shacham, in Advances in Cryptology—ASIACRYPT '01, LNCS 2248, pages 514-532, Springer-Verlag, 2001.

Identifier-Based Encryption (see dashed box 3):—Identifier based encryption allows the holder of the private key S_{ID} of an identifier based key pair (in this case, party B) to decrypt a message sent to them encrypted (by party A) using B's public key Q_{ID}.

More particularly, party A, in order to encrypt a message m, first computes:
U=rP
where r is a random element of Z^{*}ₗ. Next, party A computes:
V=m⊕H₃(p(R, rQ_{ID}))

Party A now has the ciphertext elements U and V which it sends to party B.

Decryption of the message by party B is performed by computing:

$$\begin{matrix}V ⊕ {H}_{3} ( p ( U , {S}_{ID} ) ) = V ⊕ {H}_{3} ( p ( rP , {sQ}_{ID} ) ) \\ = V ⊕ {H}_{3} ( {p ( P , {Q}_{ID} )}^{rs} ) \\ = V ⊕ {H}_{3} ( p ( sP , {rQ}_{ID} ) ) \\ = V ⊕ {H}_{3} ( p ( R , {rQ}_{ID} ) ) \\ = m\end{matrix}$$

The foregoing example encryption scheme is the “Basicldent” scheme described in the above-referenced paper by D. Boneh and M. Franklin. As noted in that paper, this basic scheme is not secure against a chosen ciphertext attack (the scheme only being described to facilitate an understanding of the principles involved—a fully secure scheme is described later on in the paper and the reader should refer to the paper for details).

Identifier-Based Signatures (see dashed box 4):—Identifier based signatures using pairings can be implemented. For example:

Party B first computes:
r=p(S_{ID}, P)^{k}
where k is a random element of Z^{*}ₗ.

Party B then applies the hash function H₂ to m∥r (concatenation of m and r) to obtain:
h=H₂(m∥r).
Thereafter party B computes
U=(k−h)S_{ID}
thus generating the output U and h as the signature on the message m.

Verification of the signature by party A can be established by computing:
r′=p(U, P)·p(Q_{ID}, R)^{h}
where the signature can only be accepted if h=H₂(m∥r′).

### SUMMARY OF THE INVENTION

According to a first aspect of the present invention, there is provided a method of providing cryptographic services in an organisation, the method comprising:
providing members of the organisation with respective smartcards, each holding a secret associated with the member concerned and arranged to map an input string to a first element of an algebraic group according to a known mapping function, to multiply the first element by said secret to form a second element of said algebraic group such that there exists a computable bilinear map for the first and second elements, and to output this second element;
the members using the smartcards in the provision of at least encryption, decryption and signing cryptographic services with the same smartcard-held secret of a member being involved as required in all these services.

Each smartcard thus need only be provided with limited cryptographic functionality, the functionality provided being selected such that the stored secret is protected but can be brought into play in respect of a variety of cryptographic services. The smartcard can, in this way, be kept functionally lightweight enabling costs to be kept down. Most of the processing involved in providing the full cryptographic services is carried out off the smartcard.

According to a second aspect of the present invention, there is provided a system for providing cryptographically-protected processes in an organisation, the system comprising:
a plurality of smartcards for use by corresponding members of the organisation, each smartcard comprising:
   a non-volatile memory for holding a secret associated with the corresponding member,
   an input arrangement for receiving an input string,
   a first functional entity for mapping said input string to a first element of an algebraic group according to a known mapping function,
   a second functional entity for multiplying the first element by said secret to form a second element of said algebraic group such that there exists a computable bilinear map for the first and second elements, and
   an output arrangement for outputting said second element;
a plurality of process sub-systems for implementing processes that, at least when considered together, involve at least encryption, decryption and signing cryptographic services involving the use of said smartcards with the same smartcard-held secret of a member being involved as required in all these services.

According to a third aspect of the present invention, there is provided a smartcard comprising:
a non-volatile memory for holding a secret associated with a user of the card, an input arrangement for receiving an input string,
a first functional entity for mapping said input string to a first element of an algebraic group according to a known mapping function,
a second functional entity for multiplying the first element by said secret to form a second element of said algebraic group such that there exists a computable bilinear map for the first and second elements, and
an output arrangement for outputting said second element.

### BRIEF DESCRIPTION OF THE DRAWINGS

Embodiments of the invention will now be described, by way of non-limiting example, with reference to the accompanying diagrammatic drawings, in which:

FIG. 1 is a diagram showing prior art cryptographic processes based on elliptic curve cryptography using Tate pairings; and

FIG. 2 is a diagram illustrating an embodiment of the invention.

### BEST MODE OF CARRYING OUT THE INVENTION

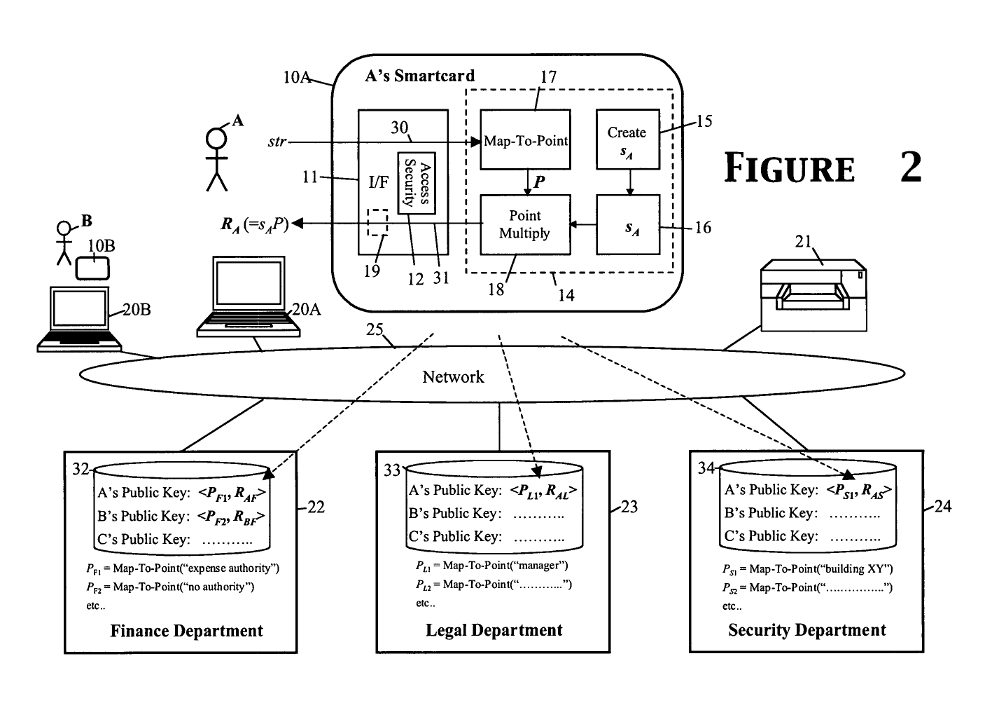

FIG. 2 depicts members A and B of an organisation that includes a finance department 22, a legal department 23 and a security department 24. Members of the organisation have respective smartcards, the smartcards of members A and B being referenced 10A and 10B respectively in FIG. 2. Members A and B also have respective computers 20A and 20B, each computer including a smartcard interface enabling a smartcard to be operatively coupled with the computer.

The departments of the organisation are interconnected by a network 25. The computers 20A and 20B are also connected to the network 25 as is a printer 21. The printer 21 has a smartcard interface by which a smartcard can be coupled to the printer.

The form of the members' smartcards will now be described with reference to the smartcard 10A of member A, the other smartcards being substantially the same. The smartcard 10A comprises an input/output interface functional block 11 and a cryptographic functional block 14 (shown in dashed outline).

The interface block 11 comprises a data input channel 30, a data output channel 31, and an access security entity 12. The interface block 11 is adapted to permit the smartcard to be coupled with a smartcard interface provided on apparatus such as the computer 20A or printer 21. The access security entity 12 is, for example, implemented to require the input of a PIN code before allowing use of the smartcard, this code being input by a user via apparatus with which the smartcard is operatively coupled.

The input channel 30 is arranged to receive an input string (generically, string str) whilst the output channel 31 is arranged to output a point on an elliptic curve (generically, point R and for smartcard 10A of member A, R_{A}). The form in which the point R_{A} is output can be set by entity 19 of interface block 11 to be, for example, of string form.

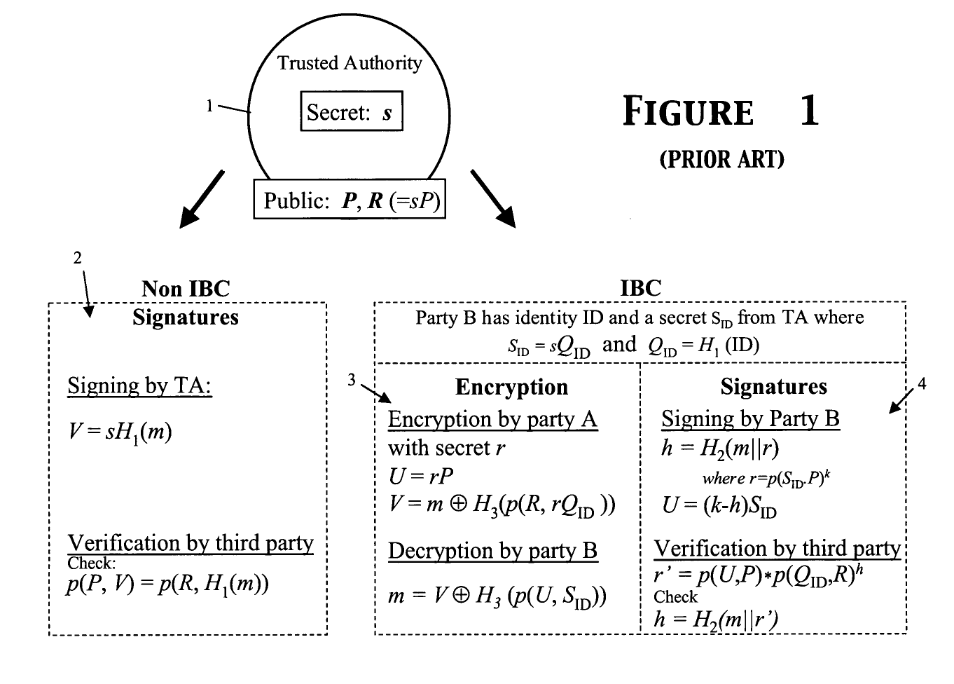

The cryptographic block 14 of smartcard 10A comprises the following functional entities:
an entity 15 for generating a random secret s_{A};
a non-volatile memory 16 for holding the secret s_{A};
a Map-To-Point entity 17 for receiving the string str from the input channel 30 and mapping this string to a first element P of an algebraic group according to a known one-way mapping function;
a product entity for multiplying the first element P by the stored secret s_{A} to form a second element R_{A} of the same algebraic group as the first element such that there exists a computable bilinear map for the first and second elements, the second element being output on output channel 31.
   Preferably, the first and second elements P and RA are points on the same elliptic curve and this will assumed hereinafter with the curve considered being the same as that used for the prior art examples described above with reference to FIG. 1. Similarly, the various hash functions already described above with reference to the FIG. 1 examples will be used for the examples given below; in particular, the Map-To-Point function implemented by entity 17 is the hash function H₁.

The secret-generator entity 15 can be omitted if the smartcard is directly manufactured with the secret s_{A} installed, or if provision is made for the secure loading of the secret into the memory via the interface 11.

As will be more fully described hereinafter, providing the member smartcards 10A, 10B etc. with the minimal cryptographic functionality represented by entities 16-18, permits the organisation of which A and B are members, to operate a range of cryptographically-secured processes involving various cryptographic functions such as signing, encryption, decryption.

In the FIG. 2 example, each of the member smartcards is used to generate a plurality of public keys <P, R_{A}>, one for each of the finance department 22, the legal department 23, and the security department 24, with each of the departments keeping a respective database 32, 33, 34 recording each member and their corresponding public key. For any given smartcard, the department public keys it generates differ from one another because each is based on a string provided to it by the department concerned, the department choosing this string to indicate, for example, some attribute it associates with the member concerned.

Thus, member A may have authority from the finance department to authorise expense requests. Accordingly, the finance department asks member A to provide a public key based on the string “expense authority” this being the first string of several possible strings that the finance department uses to describe the finance-related authority of members. Member A then uses their smartcard (for example, after operatively coupling it with their computer 20A) to take the string “expense authority” as the input string str and output a corresponding point R_{AF} (the suffix F indicating that the point relates to the Finance department). Thus:
P_{F1}=Map-To-Point(“expense authority”)
   where the suffix F1 indicates that the point P is derived from the first string, “expense authority”, used by the Finance department;
R_{AF}=s_{A}(P_{F1})
   Member A's public key for the finance department is then <P_{F1}, R_{AF}>. The point P_{F1} can be arranged to be output by the smartcard 10A along with the point R_{AF} or, preferably, since the Map-To-Point function is public, the finance department can compute P_{F1} itself Indeed, the finance department may only store the point R_{AF} as the record it keeps for member A will already record that A has expense authority so that the finance department can compute the first part of A's public key whenever needed.

Of course, the finance department needs to be sure that it really is receiving a public key generated by A's smartcard 10A before storing this in A's record in database 32. This can be achieved in a number of ways. For example, the finance department may require A to physically attend at the finance department and present A's smartcard 10A which is then coupled to processing apparatus in the department to generate the public key. In fact, this is not necessary because provided the finance department reliably knows one public key generated by A's smartcard, it can check whether a public key purportedly generated by that card from a string provided by the department is genuine. This check is based on a bilinear map p such as a Weil or Tate pairing as follows:
compute P_{F1}=Map-To-Point (“expense authority”)
check:
   p(P_{ref}, R_{AF})=p(P_{F1}, R_{Aref})
where <P_{ref}, R_{Aref}> is a trusted public key of A (however made available to the finance department). It will be appreciated that the left-hand side should be equal to the right-hand side since

$$\begin{matrix}p ( {P}_{F1} , {R}_{Aref} ) = p ( {P}_{F1} , {s}_{A} ( {P}_{ref} ) ) \\ = {p ( {P}_{F1} , {P}_{ref} )}^{{S}_{A}} \\ = p ( {s}_{A} ( {P}_{F1} ) , {P}_{ref} ) \\ = p ( {R}_{AF} , {P}_{ref} )\end{matrix}$$

Member A's department public keys for the legal department and the security department are formed in a similar way. Thus, A's public key for the legal department is formed from a string “manager” which is an attribute of A relevant to the legal department:
A's public key for the legal department: <P_{L1}, R_{AL}>
   where the suffix L indicates the Legal department and P_{L1} is formed by Map-To-Point (“manager”).
      For the security department, the string used as the basis for A's related public key is A's normal working location, here “building XY”, thus:
A's public key for the security department: <P_{S1}, R_{AS}>
   where the suffix S indicates the Security department and P_{S1} is formed by Map-To-Point (“building XY”).

Member B similarly forms its department public keys using smartcard 10B and appropriate input strings provided by each department. The string provided to B by any particular department may be the same or different to that provided to A depending on whether B has the same department related attribute. Thus, B may not have any spending authority from the Finance department so that the string used as the basis for B's public key for the finance department is “no authority” so that:
B's public key for the finance department: <P_{F2}, R_{BF}>
   where the suffix F indicates the Finance department and P_{F2} is formed by Map-To-Point (“no authority”).

Having described an application context for the smartcard 10A, several example usages will now be given.
1. Suppose that member B has incurred expenses and sends an expense refund request to the finance department. Before paying the expenses, the finance department sends the request to B's manager—in this case, member A—for authority to pay. To authorise payment, member A inserts his smartcard 10A into the smartcard interface of computer 10A and inputs his PIN to enable the smartcard 10A; member A then uses the smartcard to compute:
   R_{Areq}=s_{A}(Map-To-Point(request))
   which A sends back to the finance department as an authorising signature. The finance department then:
      computes P_{req}=Map-To-Point (request)
      looks up A's public key in database 32 and checks:
         p(P_{F1}, R_{Areq})=p(P_{req}, R_{AF})
   which will be the case if the finance department has indeed received A's authorising signature on the request.
2. The legal department 23 wishes to send a confidential document to member A. To do this, the department 23 employs identity-based encryption to encrypt the document using, as the IBE trusted-authority public data, A's public key <P_{L1}, R_{AL}> as held in database 33, and as the encryption key string EKS, the string=“date, document reference number”. Thus, for the prior art IBE encryption method depicted in FIG. 1, the department 23:
   generates secret r,
   computes:
      U=rP_{L1}
      V=m⊕H₃(t(R_{AL}, r(Map-To-Point(EKS))))
   where m is the confidential document
   sends <U,V, EKS> to member A.

To decrypt the message, member A inserts his smartcard 10A into his computer's smartcard interface, authenticates himself to the smartcard by inputting his PIN, and uses the smartcard to compute the decryption key:
R_{Adec}=s_{A}(Map-To-Point(EKS))
This decryption key is output to A's computer, and the computer then decrypts the document as follows:
m=V⊕H₃(t(U, RAdec))
In this example, the encryption key string EKS is likely to change each time, that is, EKS and thus the decryption key R_{Adec} are session keys. However, in certain applications the EKS may be re-used so that the corresponding decryption key can be stored (securely) as a long-term key. It will be appreciated that not only the departments, but also any other member, can send data confidentially to member A using the foregoing method, A then using his smartcard in the decryption of the data.
3. In a variant of foregoing example usage, the member A encrypts data to be printed using an IBE encryption method such as described above using any public key created using A's smartcard, and any suitable encryption key string EKS. The public key can for example, be one specifically created using smartcard 10A for the current encryption operation. The set of elements <U,V, EKS> is sent to the printer 21 where it is held until member A attends the printer and inserts the smartcard into the smartcard interface of the printer. After A has entered his PIN via a user interface of the printer, the smartcard 10A is enabled to generate the decryption key needed to decrypt the data. The decryption key is used by the printer to decrypt the data which is then printed.
4. In both of the preceding two example usages, the smartcard 10A of member A has not truly been used in the role of an IBE trusted authority because the decrypting entity has effectively been member A (in fact, in both examples, the decrypting entity is actually apparatus at least temporarily under the control of member A). However, it is possible for A's smartcard to be truly used in the role of an IBE trusted authority. For example, a document may be sent encrypted to a member managed by member A, the document being encrypted as in the second example usage. In order for the recipient member to decrypt the document, they must obtain the decryption key from member A. This gives A the opportunity to exercise their discretion in deciding whether or not to allow the recipient member to access the document. In such cases, the encryption key string advantageously contains information for assisting A in coming a decision—indeed, the encryption key string can include one or more conditions concerning the recipient that A must check before providing the decryption key.
5. In a further example usage, the member A sometimes works at the office during the weekend and when A does this he is required to register with the security department (which always has an on-site presence). This registration can be done automatically by arranging for A's access to the building where he works to be made subject to insertion of his smartcard 10A into an entry smartcard interface. After A has entered his PIN via this interface to enable the smartcard, the entry interface inputs a current time string into the smartcard and sends the resultant output and the input time string to the security department (preferably along with an identifier of the member A, such as a card number electronically read from the card). The security department looks up the stored public key <P_{S1}, R_{AS}> for the identified party in database 34 and uses this public key to verify that the data received from the entry smartcard interface has been produced with the current involvement of A's smartcard. If the verification is satisfactory, A is allowed into the building and this fact is recorded. As an additional security measure, the security department could also issue a challenge based on a nonce (random number) to A's smartcard, this nonce being provided as input to the card and the output then verified by the security department in the manner already described.

The above example usages are not exhaustive. For example, the signature process 4 of FIG. 1 can also be implemented. Furthermore, the smartcards can be used to enforce processes that require the involvement of multiple members. Thus, a document can be IBE encrypted using public data produced by the smartcards of multiple members (that is, by multiple trusted authorities), decryption of the encrypted item only being possible by obtaining a decryption sub-key from each smartcard. Further information about how multiple trust authorities can be used is given in the paper: Chen L., K. Harrison, A. Moss, N. P. Smart and D. Soldera. “Certification of public keys within an identity based system” Proceedings of Information Security Conference 2002, ed. A. H. Chan and V. Gligor, LNCS 2433, pages 322-333, Springer-Verlag, 2002.

It will be appreciated that many variants are possible to the above described embodiments of the invention. Thus the access control entity 12 and output form entity 19 of the smartcard interface block 11 can be omitted if desired. Furthermore, whilst in the foregoing user interaction with a smartcard has been via apparatus to which the smartcard is coupled by its interface 1, it is also possible to provide user interface elements on the smartcard itself such as a number pad (for data input) and an LCD display (for data output). The smartcard can contain additional functionality including, though not preferred, other cryptographic functionality.

1. A method of providing cryptographic services in an organisation, the method comprising:
providing members of the organisation with respective smartcards, each holding a secret associated with the member concerned and arranged to map an input string to a first element of an algebraic group according to a known mapping function, to multiply the first element by said secret to form a second element of said algebraic group such that there exists a computable bilinear map for the first and second elements, and to output this second element;
the members using the smartcards in the provision of at least encryption, decryption and signing cryptographic services with the same smartcard-held secret of a member being involved as required in all these services.

2. A method according to claim 1, wherein the smartcard of at least one member is used to produce a respective public key for each of a plurality of entities within said organisation, each such public key comprising the smartcard output resulting from using as said input string for the smartcard an attribute string provided by the entity concerned.

3. A method according to claim 1, wherein:
the smartcard of each member is used to produce a respective public key each comprising a said first element P and corresponding second element R;
a said member A with public key <P_{A},R_{A}> uses their smartcard to sign a subject string m by applying the subject string m to the smartcard as said input string and using the resultant output as its signature for the subject string; and
a recipient of the subject string and signature checks the signature by verifying that:
(P_{A}, signature)=(R_{A}, H₁(m))
where H₁( ) is said known mapping function.

4. A method according to claim 1, wherein:
the smartcard of each member is used to produce a respective public key each comprising a said first element P and corresponding second element R;
a subject string m is encrypted for decryption with the involvement of a said member A who has an associated public key <P_{A},R_{A}>, the subject string being encrypted by an Identifier-Based Encryption process based on bilinear mappings and using as encryption parameters both R_{A} and a non-secret encryption key string.

5. A method according to claim 4, wherein the encrypted subject string m is recovered by inputting the non-secret encryption key string into the smartcard of the member A and using the resultant output as a decryption key in decrypting the encrypted subject string.

6. A method according to claim 5, wherein the encrypted subject string and the non-secret encryption key string are provided to processing apparatus that is associated with A and includes a smartcard interface, member A presenting their smartcard to the smartcard interface of the processing apparatus to enable the apparatus to use the smartcard to obtain the decryption key which the apparatus then uses to decrypt the encrypted subject string.

7. A method according to claim 5, wherein the encrypted subject string and the non-secret encryption key string are provided to a printer that has a smartcard interface, member A presenting their smartcard to the printer's smartcard interface to enable the printer to use the smartcard to obtain the decryption key which the printer then uses to decrypt the encrypted subject string for printing.

8. A method according to claim 1, wherein a said member A acts as a trusted authority in respect of an Identifier-Based Cryptography, IBC, service based on bilinear mappings; the member A providing a secret key for use in said IBC service after having confirmed that at least one condition specified in an encryption key string has been met, the member A using their smart card to generate said secret key by applying the encryption key string to the smartcard as said input string and using the resultant output as the secret key.

9. A method according to claim 1, wherein the form of the second element is converted for output from the smartcard

10. A method according to claim 1, wherein apart from any usage-security and secret generation features that may be present, the smartcards contain no cryptographic service functionality additional to the functionality associated with mapping a said input string to a said first element and multiplying this element by said secret.

11. A method according to claim 1, wherein the first and second elements are points on the same elliptic curve.

12. A method according to claim 11, wherein said bilinear mapping function is based on a Tate or Weil pairing.

13. A system for providing cryptographically-protected processes in an organisation, the system comprising:
a plurality of smartcards for use by corresponding members of the organisation, each smartcard comprising:
a non-volatile memory for holding a secret associated with the corresponding member,
an input arrangement for receiving an input string,
a first functional entity for mapping said input string to a first element of an algebraic group according to a known mapping function,
a second functional entity for multiplying the first element by said secret to form a second element of said algebraic group such that there exists a computable bilinear map for the first and second elements, and
an output arrangement for outputting said second element;
a plurality of process sub-systems for implementing processes that, at least when considered together, involve at least encryption, decryption and signing cryptographic services involving the use of said smartcards with the same smartcard-held secret of a member being involved as required in all these services.

14. A system according to claim 13, wherein each sub-system is arranged to store a respective public key produced by the smartcard of a said member, each such public key comprising the second element resulting from using as said input string for the smartcard an attribute string provided by sub-system concerned.

15. A system according to claim 13, wherein at least one said sub-system is arranged to require signing of a subject string m by a said member A using their smartcard to process the subject string as said input string and present the resultant second element as a signature, the said at least one subsystem being arranged to check the signature by verifying that:
(P_{A}, signature)=(R_{A}, H₁(m))
where:
H₁( ) is said known mapping function, and
<P_{A},R_{A}> is a trusted public key associated with the member A with P_{A} being a said first element, and R_{A} being a said second element, produced by use of the smart card of the member A.

16. A system according to claim 13, wherein at least one said sub-system is arranged to encrypt a subject string m for decryption with the involvement of a said member A who has an associated public key <P_{A},R_{A}> where P_{A} is a said first element, and R_{A} a said second element, produced by use of the smart card of the member A, the said at least one sub-system being arranged to encrypt said subject string m by an Identifier-Based Encryption method based on bilinear mappings and using as encryption parameters both RA and a non-secret encryption key string.

17. A system according to claim 16, wherein said at least one said sub-system is arranged to recover the encrypted subject string m by inputting the non-secret encryption key string into the smartcard of the member A and using the resultant output as a decryption key in decrypting the encrypted subject string.

18. A system according to claim 13, wherein at least one said sub-system is arranged to use a said member A as a trusted authority in respect of an Identifier-Based Cryptography service based on bilinear mappings; said at least one said sub-system being arranged to provide the member A with an encryption key string for presentation as said input string to A's smartcard, and to receive back the resultant second element as a decryption key.

19. A system according to claim 13, wherein the output arrangement of each smartcard is arranged to change the form of the second element prior to output from the smartcard.

20. A system according to claim 13, wherein apart from any usage-security and secret generation features that may be present, the smartcards contain no cryptographic service functionality additional to the functionality associated with mapping a said input string to a said first element and multiplying this element by said secret.

21. A system according to claim 13, wherein the first and second elements are points on the same elliptic curve.

22. A system according to claim 21, wherein said bilinear mapping function is based on a Tate or Weil pairing.

23. A smartcard comprising:
a non-volatile memory for holding a secret associated with a user of the card,
an input arrangement for receiving an input string,
a first functional entity for mapping said input string to a first element of an algebraic group according to a known mapping function,
a second functional entity for multiplying the first element by said secret to form a second element of said algebraic group such that there exists a computable bilinear map for the first and second elements, and
an output arrangement for outputting said second element.

24. A smartcard according to claim 23, wherein the output arrangement of each smartcard is arranged to change the form of the second element prior to output from the smartcard.

25. A smartcard according to claim 23, wherein apart from any usage-security and secret generation features that may be present, the smartcard contain no cryptographic service functionality additional to the functionality associated with mapping a said input string to a said first element and multiplying this element by said secret.

26. A smartcard according to claim 23, wherein the first and second elements are points on the same elliptic curve.

30. A smartcard according to claim 29, wherein said bilinear mapping function is based on a Tate or Weil pairing.
